(19) United States
(12) Patent Application Publication
(10) Pub. No.: US 2026/0061580 A1
(43) Pub. Date: Mar. 5, 2026

(54) DRIVING TOOL

(71) Applicant: MAKITA CORPORATION, Anjo-shi (JP)

(72) Inventors: Nobuyuki Hoshiyama, Anjo-shi (JP); Masaya Nagao, Anjo-shi (JP)

(73) Assignee: MAKITA CORPORATION, Anjo-shi (JP)

(21) Appl. No.: 19/239,525

(22) Filed: Jun. 16, 2025

(30) Foreign Application Priority Data
Aug. 28, 2024 (JP) 2024-146295
Mar. 12, 2025 (JP) 2025-039243

(51) Int. Cl. B25C 1/00; B25C 1/06

(52) U.S. Cl. CPC B25C 1/005; B25C 1/008; B25C 1/06

(57) ABSTRACT

A driving tool features a lock mechanism that secures a magazine to the tool main body and simplifies its removal process. The driving tool has a lock member for securing the magazine and an operation member for enabling magazine removal. The driving tool also has an extrusion portion formed in the operation member. The extrusion portion is configured to push the magazine in a removal direction during unlocking process.

### CROSS-REFERENCE TO RELATED APPLICATION

This application claims priority to Japanese patent application serial number 2024-146295, filed on Aug. 28, 2024, and to Japanese patent application serial number 2025-039243, filed on Mar. 12, 2025, the contents of which are incorporated herein by reference in their entirety for all purposes.

### TECHNICAL FIELD

The present disclosure generally relates to a driving tool with a magazine that can be loaded with a large number of driving members.

### BACKGROUND

A driving tool for driving nails into, for example, concrete, is configured such that a magazine loaded with driving members can be detached from a tool main body of the driving tool in order to remove a driving member when the driving member is stuck in a nose section. A driving tool is well known which is configured such that a magazine is attachable by engaging an end portion of the magazine in a feeding direction with a nose portion of a tool main body of the driving tool to engage a rear portion of an operation member of the magazine with the tool main body. The magazine is removable from the tool main body by moving the operation member to an unlock side and moving the rear portion of the magazine in a disengaging direction.

For another example, a driving tool is well known which is configured such that a magazine slidably engages a slide base protruding from a nose portion of the tool in a lateral direction. The magazine is attachable by engaging an operation member on a rear side of the slide base with a lock portion on a rear side of the magazine. The magazine is removable by moving the operation member to an unlock side to disengage from the lock portion to slide the magazine in a removal direction.

In the above-described driving tools, the magazine is removable by moving the operation member to the unlock side and then moving the magazine in the removal direction. Therefore, the removal operation is troublesome in that a user needs to perform two operations. Thus, there is a need to improve operability for removing the magazine of the driving tool.

### SUMMARY OF THE DISCLOSURES

According to one aspect of the present disclosure, a driving tool has a tool body configured to drive a driving member and a magazine configured to be detachably attachable to the tool main body and house a numbers of driving members. The driving tool has a lock member configured to lock (secure) the magazine within the tool main body so as not to be disengaged from the tool main body, and an operation member configured to move the lock member from a lock position to an unlock position by an operation of the operation member. The driving tool has an extrusion portion formed in the operation member. The extrusion portion pushes the magazine in a removal direction with respect to the tool main body through the operation of the operation member to move the lock member to the unlock position.

Because of this configuration, when the operation member moves the lock member to the unlock position, the locked state of the magazine by the lock member is released and the magazine is pushed in the removal direction by the extrusion portion of the operation member. Because of this movement, operability of the magazine can be improved when removing the magazine.

### BRIEF DESCRIPTION OF DRAWINGS

FIG. 1 is an overall side view of a driving tool.

FIG. 2 is a left side view of the driving tool which shows an internal structure of the driving tool. This figure shows a state in which the magazine is attached to the driving tool.

FIG. 3 is a left side view of the driving tool which shows the internal structure of the driving tool. This view shows a state in which the magazine is detached from the driving tool.

FIG. 4 is a right side view of a magazine lock portion. This figure shows a state in which the magazine is detached from the driving tool.

FIG. 5 is a left side view of a magazine unit.

FIG. 6 is a perspective view of a nose portion of the driving tool without the magazine when viewed from below.

FIG. 7 is an enlarged view of part VII in FIG. 2. This figure shows the magazine lock portion is in a locked state.

FIG. 8 is an enlarged view of part VIII in FIG. 3. This figure shows the magazine lock portion is in an unlocked state.

FIG. 9 is a perspective view of a lower part of the magazine and the magazine lock portion when viewed obliquely from below on the left side, showing that the magazine lock portion is in a locked state.

FIG. 10 is a perspective view of the lower part of the magazine and the magazine lock portion, which is viewed in a direction indicated by an arrow X in FIG. 9.

FIG. 11 is a perspective view of the magazine lock portion without an operation portion, which is viewed from a left side thereof.

FIG. 12 is a perspective view of an operation member unit.

FIG. 13 is a perspective view of the magazine lock portion without the magazine. This figure shows a magazine lock window obliquely viewed from the front on the left side.

FIG. 14 is a left side view of the driving tool according to a second embodiment of the present disclosure.

FIG. 15 is a left side view of the magazine lock portion according to the second embodiment. This figure shows that the magazine lock portion is in a locked state.

FIG. 16 is a left side view of the magazine lock portion according to the second embodiment. This figure shows that the magazine lock portion is in an unlocked state.

### DETAILED DESCRIPTION

The detailed description set forth below, when considered with the appended drawings, is intended to be a description of exemplary embodiments of the present disclosure and is not intended to be restrictive and/or representative of the only embodiments in which the present disclosure can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the disclosure. It will be apparent to those skilled in the art that the exemplary embodiments of the disclosure may be practiced without these specific details. In some instances, these specific details refer to well-known structures, components, and/or devices that are shown in block diagram form in order to avoid obscuring significant aspects of the exemplary embodiments presented herein.

According to another aspect of the present disclosure, the lock member and the operation member are formed to be separate and movable within the tool main body. Because of this configuration, the operation direction of the operation member and the movement direction of lock member toward the unlocked position are different to each other, thereby locking the magazine at the attachment position more reliably in a compact configuration.

According to another aspect of the present disclosure, the driving tool has a stopper formed in the operation member. The stopper is configured to prevent the lock member from moving to the unlocked position and to allow the lock member to move to the unlock position when the operation member is operated. Because of this configuration, the magazine can be locked at the attachment position by the stopper more reliably.

According to another aspect of the present disclosure, an operation direction of the operation member intersects both a loading direction of the driving member in the magazine and a driving direction of the driving member in the tool main body. Because of this configuration, the magazine can be removed by operating the operation member 42 in the lateral direction while the driving tool is grasped.

According to another aspect of the present disclosure, the lock member is rotatably supported by the tool main body around a support shaft extending in parallel with an operation direction of the operation member. Because of this configuration, the operation member and the lock member can be arranged in a compact manner.

According to another aspect of the present disclosure, the lock member and the operation member are integrally formed and movable with respect to the tool main body. Accordingly, a configuration of the lock member and the operation member can be simplified.

According to another aspect of the present disclosure, the lock member moves between the lock position and the unlock position by rotation of the lock member. Because of this configuration, a removing operability of the magazine can be improved.

According to another aspect of the present disclosure, the driving tool has a lock engaging portion formed in the magazine and configured to contact the extrusion portion of the operation member. At least one of the extrusion portion and the lock engaging portion has an operation force conversion surface via which an operation direction of the operation member is converted to the removal direction of the magazine. Because of this configuration, the magazine is pushed in the removal direction by the operation force of the operation member.

According to another aspect of the present disclosure, the driving tool has a biasing member configured to bias the lock member toward the lock position. A biasing force of the biasing member is also applied in the removal direction of the magazine. Because of this configuration, the magazine is pushed in the removal direction by the biasing force of the biasing member.

According to another aspect of the present disclosure, the driving tool has a lock guide portion and a lock recess both formed in the magazine. The lock guide portion slidably contacts the lock member when the magazine is attached to the tool main body, and the lock recess is configured to engage the lock member. When the magazine is removed from the tool main body, the lock guide portion is pushed in the removal direction of the magazine by the lock member owing to the biasing force of the biasing member. Because of this configuration, the lock guide portion functions effectively in both cases where the magazine is attached to and detached from the lock housing.

According to another aspect of the present disclosure, the driving tool has a structure in which the magazine is pushed in the removal direction by the operation of the operation member, and the magazine is further pushed in the removal direction by the biasing force of biasing member when the lock member moves to the unlock position. Because of this configuration, the magazine is removed from the tool main body through a first stage in which the magazine is pushed in the removal direction by the operation member and a second stage in which the magazine is pushed in the removal direction by the biasing force of the biasing member.

According to another aspect of the present disclosure, the driving tool has a nose which is formed in the tool main body and extends in a driving direction of the driving member. The nose is attachable to the magazine. The magazine is pushed to a side of the nose when the magazine is attached to the tool main body. Because of this configuration, the magazine can be attached to the nose without rattling.

According to another aspect of the present disclosure, the magazine is configured to be locked (secured) in an attachment position by the lock member when the magazine moves to a side of the tool main body. Because of this configuration, the magazine can be attached to the tool main body with a one-touch operation.

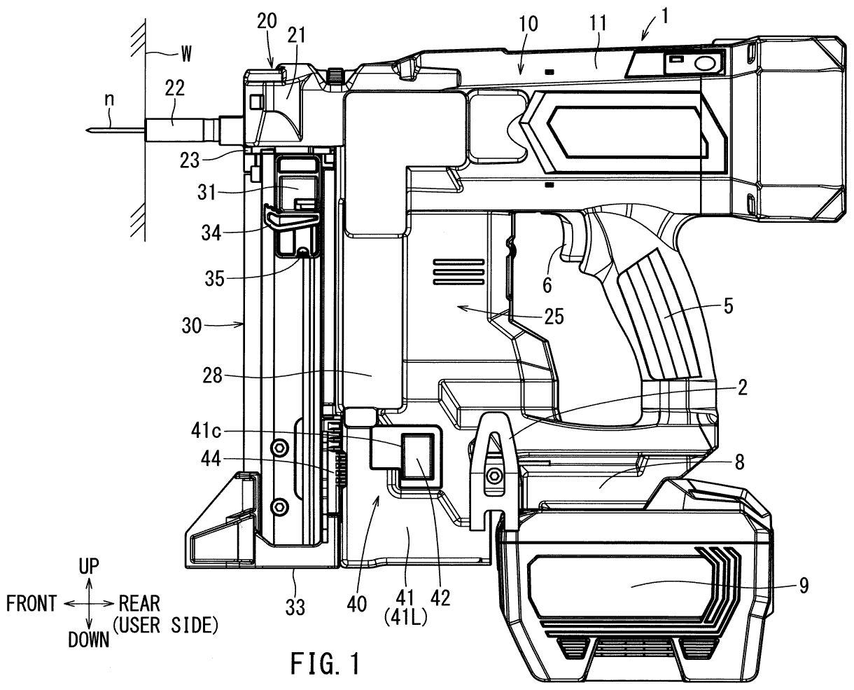

One embodiment of the present disclosure will be explained in the following. FIGS. 1 to 3 show a gas spring type driving tool as one example of the driving tool, which uses a gas pressure in an accumulation chamber behind a cylinder as a thrust force for a driving member n. In the following explanation, a direction of each component of the driving tool will be specified in a case where the driving tool 1 is held in such a posture that a driving member n is driven into a workpiece W (wall surface) as shown in FIG. 1. A user of the driving tool 1 is generally located behind the driving tool 1 in FIG. 1. A driving direction of the driving member n is a forward direction, and a direction opposite to the direction is a rearward direction. An up-down direction and a left-right direction are based on a user's position.

As shown in FIG. 1, the driving tool 1 has a tool main body 10. The tool main body 10 has a cylinder 12 housed in a main body housing 11 formed in generally in a cylindrical shape. A piston 13 is housed in the cylinder 12 so as to be reciprocatable in a front-rear direction. A driver 15 for driving the driving member N is coupled to a front center of the piston 13. The driver 15 is a long rod-shaped member extending in the forward direction.

The tool main body 10 has a nose 20 located at a front portion of the tool main body 10. The nose 20 includes a driving passage 20a. A front portion of the driver 15 enters the driving passage 20a. Also, the nose 20 includes a nose frame 21 coupled to the front of the main body housing 11 and a cylindrical-shaped ejection port 22 protruding forward from the nose frame 21. The driving passage 20a passes through the nose frame 21 and ejection port 22 in the front-rear direction. A driving member n supplied in the driving passage 20a is driven by the driver 15. The driving member n driven by the driver 15 ejects from an end portion of the ejection port 22.

A rear portion of the cylinder 12 behind the piston 13 is connected to the accumulation chamber 14. The accumulation chamber 14 is filled with a compressed gas, for example, an air. A gas pressure in the accumulation chamber 14 acts on a rear surface of the piston 13 as a thrust force for moving the piston 13 forward in the driving direction.

The piston 13 and the driver 15, which move in the driving direction by the gas pressure, are returned to a standby position in a rearward direction by a lift mechanism 25. The lift mechanism 25 is arranged extending downward from a front portion of the tool main body 10. The lift mechanism 25 has a lift wheel 27 that is rotated by an electric motor 26. A motor axis of the electric motor 26 and a rotation axis of the lift wheel 27 are mutually coaxial and perpendicular to a moving direction of the driver 15, i.e. the font-rear direction.

The driver 15 and the piston 13 are returned to the standby position in the rearward direction by rotation of the lift wheel 27 which engages the driver 15 moved to a front end by the driving operation. When the electric motor 26 is activated in the standby position, the driver 15 moves further in the rearward direction, thereby disengaging the lift wheel 27 from the driver 15. Because of this movement, the driver 15 moves forward to perform the driving operation.

A grip 5 is arranged behind the lift mechanism 25 for a user to grasp. The grip 5 is formed extending downward from a lateral portion of the tool main body 10. A switch lever 6 is arranged on an upper front surface of the grip 5 for the user to operate by pulling with his or her fingertips. When the switch lever 6 is pulled, a switch main body 7 is turned on and the electric motor 26 of the lift mechanism 25 is activated.

A controller 29 formed in a rectangular flat shape is arranged in front of the lift mechanism 25 and the electric motor 26. The controller 29 extends in the up-down direction. The lift mechanism 25, the electric motor 26, and the controller 29 are housed in a lift housing 28 formed in an approximately cylindrical shape.

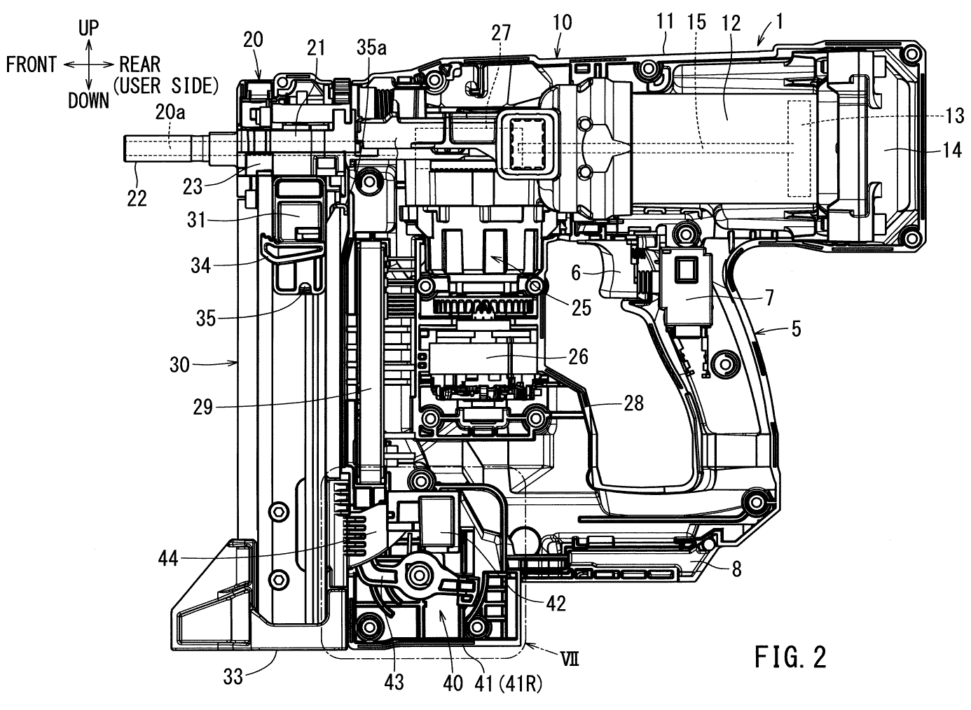

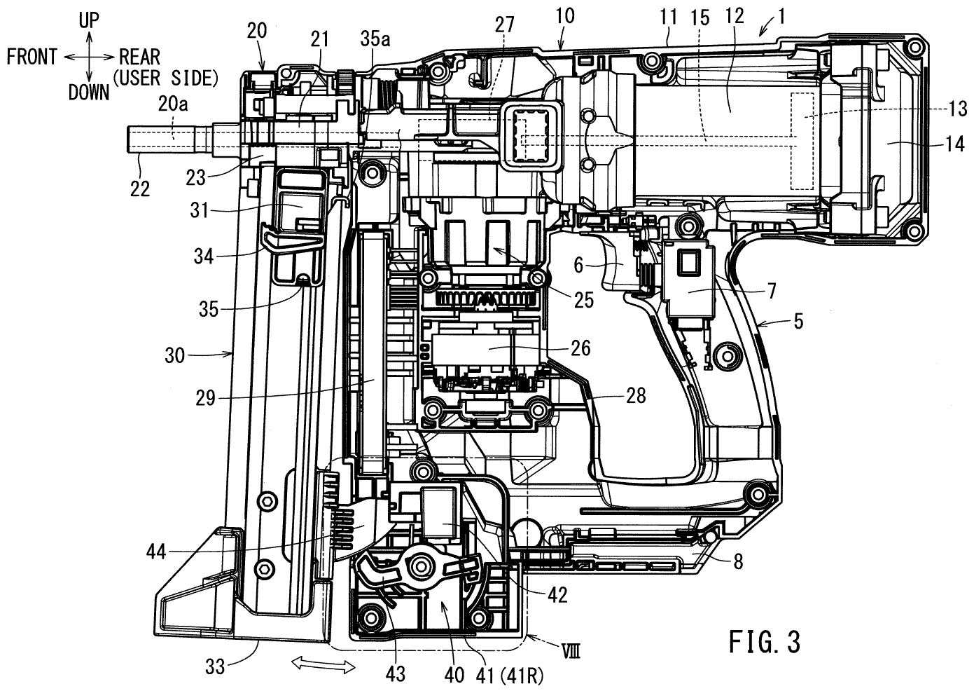

A battery attachment portion 8 is arranged at the bottom portion of grip 5. As shown in FIG. 1, one battery pack 9 is attachable to a lower surface of the battery attachment portion 8. The battery pack 9 can be attached to and removed from the battery attachment portion 8 by sliding the battery pack 9 in the front-rear direction. FIGS. 2 and 3 show the battery pack 9 is removed from the battery attachment portion 8.

Referring to FIG. 1, a hook 2 is arranged on the left side of the front portion of the battery attachment portion 8. When the driving tool 1 is not used, the hook 2 can be used to hook to, for example, a user's a waist belt for hanging the driving tool 1.

A front portion of the battery attachment portion 8 is coupled to the lower portion of the lift housing 28. The main body housing 11, the lift housing 28, the grip 5, and battery attachment portion 8 are integrally formed to each other to have a left and right half-split housing structure.

The ejection port 22 of the nose 20 is displaceable in the front-rear direction within a certain range relative to the nose frame 21. When the ejection port 22 contacts the workpiece W and the driving tool 1 is pressed in the driving direction, the ejection port 22 is moved rearward relative to the nose frame 21 (on-operated state). In other words, when the driving tool 1 is pressed against the workpiece W, the ejection port 33 moves rearward into the “on-operated state”, enabling the driving operation. A driving operation can be performed when the switch lever 6 is pulled while the ejection port 22 is in the on-operated state. Because of this configuration, an unintentional driving operation can be avoided.

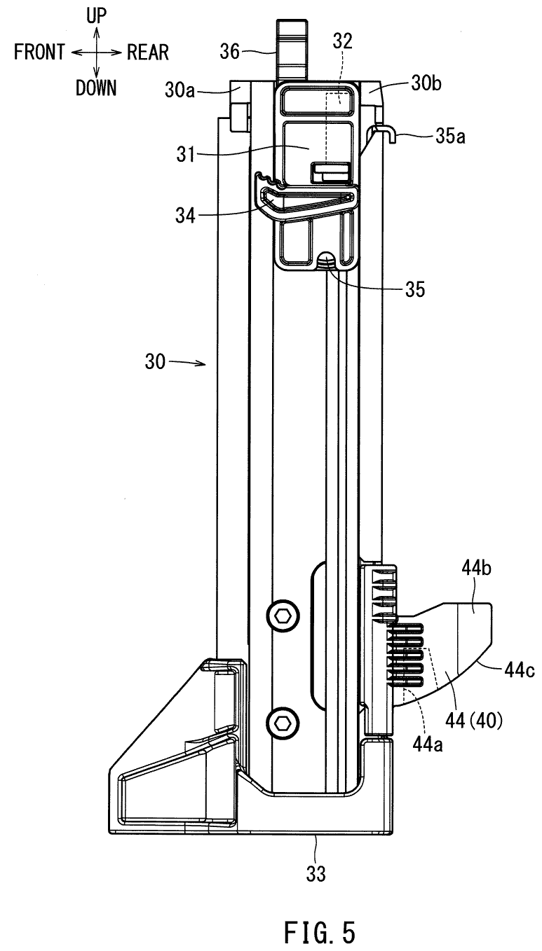

A magazine 30 is removably attachable to the tool main body 10. The magazine 30 is coupled to the lower surface of the nose 20 via a magazine 23. A magazine base 23 is arranged along the lower surface of the nose frame 21. An upper portion of the magazine 30 is attachable to the magazine base 23. Referring to FIG. 5, the magazine 30 is made primarily of a drawn material such as, for example, aluminum and formed in a rectangular shape extending in the up-down direction. The magazine 30 is arranged in front of the lift mechanism 25. A large number of driving members n, which are temporarily joined in parallel as a flat-plate-shaped connecting band, are loaded to the magazine 30.

Referring to FIG. 5, a pusher 31 is arranged in the magazine 30. The pusher 31 includes a feed claw 32, a regulating claw 36, and a coil spring 35. The feed claw 32 engages a last driving member n in the connecting band loaded to the magazine 30. Because of this configuration, the driving members n are pushed toward the driving passage 20a. The regulating claw 36 enters behind the ejection port 22 when a remaining quantity of driving members n in the magazine 30 becomes small. Accordingly, a rearward movement of the ejection port 22 is restricted by the regulating claw 36, thereby preventing a so-called “empty shot”.

The pusher 31 is biased in a feeding direction (upward direction) of the driving member n by the coil spring 35. An end portion 35a of the coil spring 35 is hooked to an upper portion of the magazine 30. The driving members n in the connecting band are pushed by the pusher 31 toward the driving passage 20a. The driving members n are supplied one by one into the driving passage 20a of the nose 20 in conjunction with the driving operation of the tool main body 10.

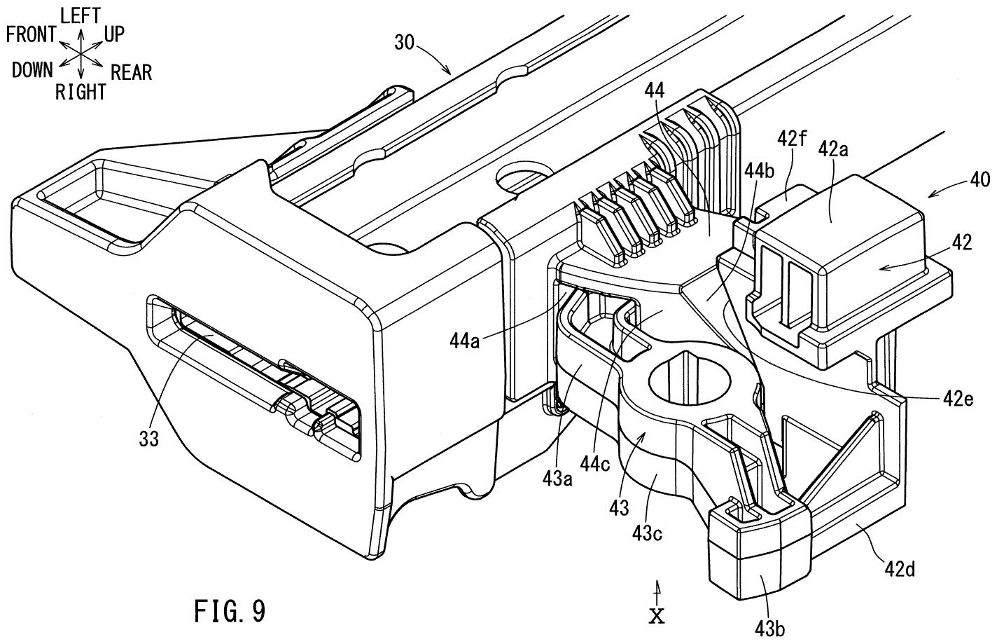

As shown in FIGS. 9 to 11, a loading hole 33 is formed at a lower portion of magazine 30. The connecting band of driving member n is loadable from the loading hole 33. As shown in FIG. 5, the pusher 31 includes a knob portion 34. When the driving members n are loaded to the magazine 30, the pusher 31 can be moved downward against the coil spring 35 by use of the knob portion 34. During the downward movement of the knob portion 34, the feed claw 32 may be retracted from an engagement position with the driving member n. Once the pusher 31 is moved downward toward the connecting band of driving members n, the feed claw 32 engages the last driving member n. Because of this configuration, the driving member n loaded to the magazine 30 is pushed toward the driving passage 20a of the nose 20.

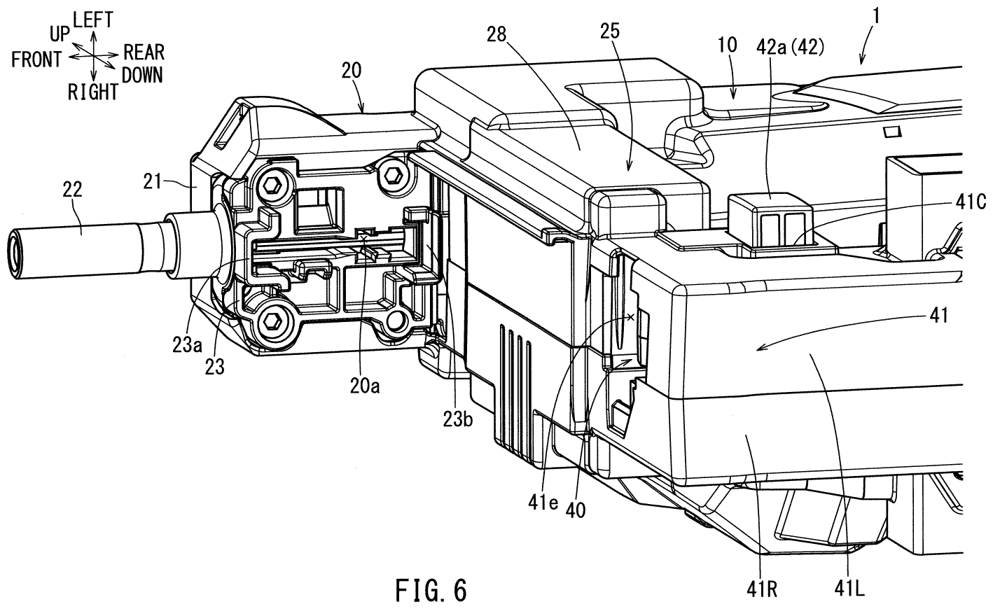

The magazine 30 is removable from the nose 20. This facilitates a removal work of a driving member n jammed in the nose 20. The magazine 30 includes front and rear engaging portions 30a and 30b at an upper portion thereof. As shown in FIG. 6, the magazine base 23 includes a pair of magazine receiving portions 23a, 23b arranged along the front-rear direction. A driving passage 20a is open between the front and rear magazine receiving portions 23a and 23b. A driving members n is supplied into the driving passage 20a through the front and rear magazine receiving portions 23a, 23b.

The magazine 30 is coupled to the magazine base 23 by engaging the front engaging portion 30a with the front magazine receiving portion 23a, and the rear engaging portion 30b with the rear magazine receiving portion 23b. When the magazine 30 is attached to the magazine base 23, an entirety of the magazine 30 is rotated rearward around the engaging portion of the front side engaging portion 30a with regard to the front side magazine receiving portion 23a, as shown by an a void arrow in FIG. 3. Because of this movement, the rear engaging portion 30b engages the rear magazine receiving portion 23b of the magazine base 23, thereby attaching the magazine 30 to the magazine base 23 so as to be parallel to the lift mechanism 25 as shown in FIGS. 1 and 2.

To remove the magazine 30 from the magazine base 23, the entirety of the magazine 30 is rotated forward around the engaging portion of the front side engaging portion 30a with regard to the front side magazine receiving portion 23a, as shown by the void arrow in FIG. 3. Because of this movement, the rear engaging portion 30b detaches from the rear magazine receiving portion 23b of the magazine base 23, thereby moving the magazine 20 to a removal position as shown in FIG. 3. FIG. 3 shows that a lower side of the magazine 30 is farther away from the lift housing 28 as it extends downward. The magazine 30 can be completely removed from the magazine base 23 by rotating the magazine 30 to the removal position.

The magazine 30 is fixable to the magazine base 23 by use of a magazine lock portion 40. The magazine lock portion 40 includes an operation member 42 and a lock member 43, which is arranged on a side of the tool main body 10. The magazine lock portion 40 also includes a lock engaging portion 44 which is arranged on a side of the magazine 30. The operation member 42 and the lock member 43 are supported by the lock housing 41. The lock housing 41 is integrally formed with a lower portion of the lift housing 28, ensuring compactness and structural stability. Similar to the lift housing 28, the lock housing 41 has a left and right half-split housing structure, including a right housing 41R and a left housing 41L, which are abutted against each other. The lock engaging portion 44 is arranged on the lower side of the magazine 30.

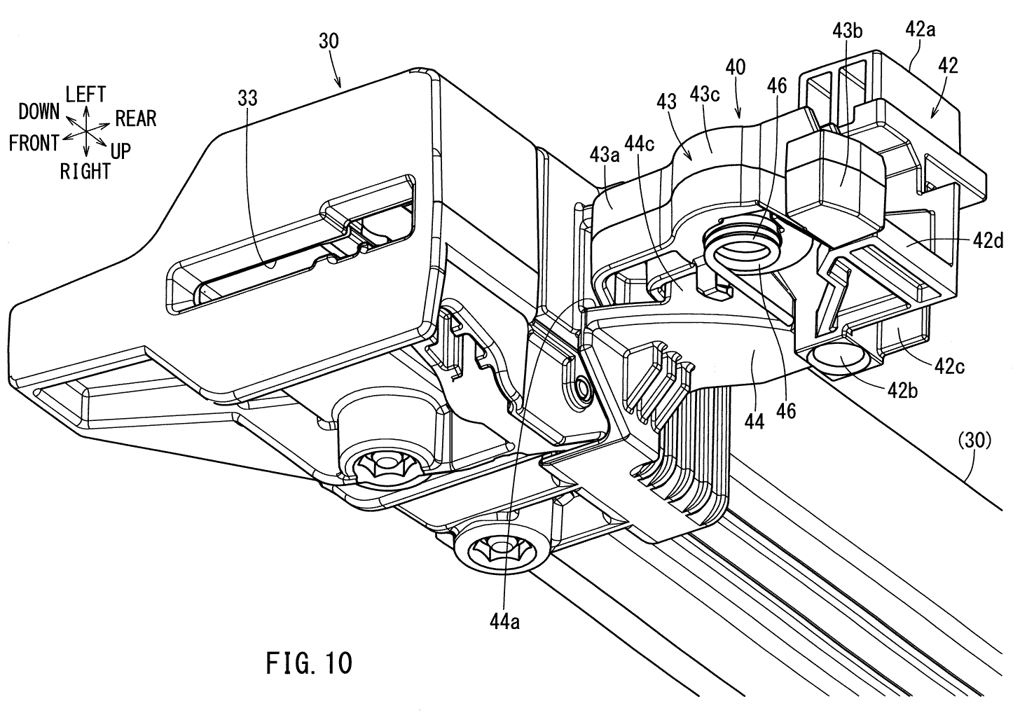

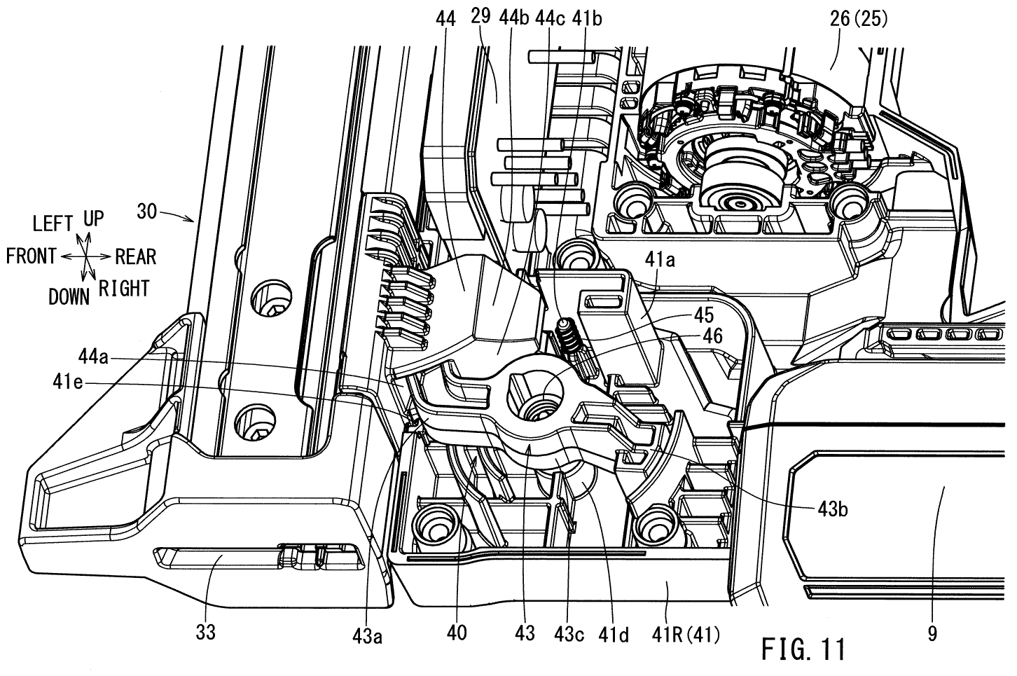

As shown in FIG. 11, the right housing 41R of the lock housing 41 includes a support pole 41a and a retention pole 41b to guide and support the operation member's movement. The support pole 41a is formed in approximately a prismatic shape. The retention pole 41b is formed in approximately a cylindrical shape. The support pole 41a and the retention pole 41b extend leftward parallel to each other. As shown in FIG. 10, a square retention groove 42c and a circular retention hole 42b are formed in a right portion of the operation member 42. The support pole 41a is positioned within the retention groove 42c and the operation member 42 is supported so as to be movable in the left-right direction between a lock side on the left side and an unlock side on the right side.

As shown in FIG. 11, a compression spring 45 is held in the retention pole 41b. The retention pole 41b and the compression spring 45 are retained in the retention hole 42b. The compression spring 45 biases the operation member 42 toward the lock side (to the left).

A rectangular prismatic-shaped operation portion 42a is formed on the left portion of the operation member 42. As shown in FIGS. 1 and 6, a rectangular window 41c is formed in the left housing 41L of the lock housing 41. The operation portion 42a of the lock member 42 protrudes outside of the lock housing 41 through the window 41c. The user can apply a fingertip to the operation portion 42a and push the operation member 42 toward the unlock side (to the right) against the biasing force of the compression spring 45.

As shown in FIGS. 9, 10, and 12, a stopper 42d is integrally formed in the operation member 42 on the right side thereof. The stopper 42d is arranged to extend in a direction toward the lock member 43. The stopper 42d restricts the lock member 43 from moving to the unlock position. Accordingly, the lock member 43 does not rotate to the unlock position unless the operation member 42 is pushed toward the unlock side. Therefore, even if the magazine 30 is pulled in the removal direction without pushing the operation member 42 toward the unlock side, the locked state of the magazine 30 cannot be released because the lock member 43 cannot rotate to the unlock position.

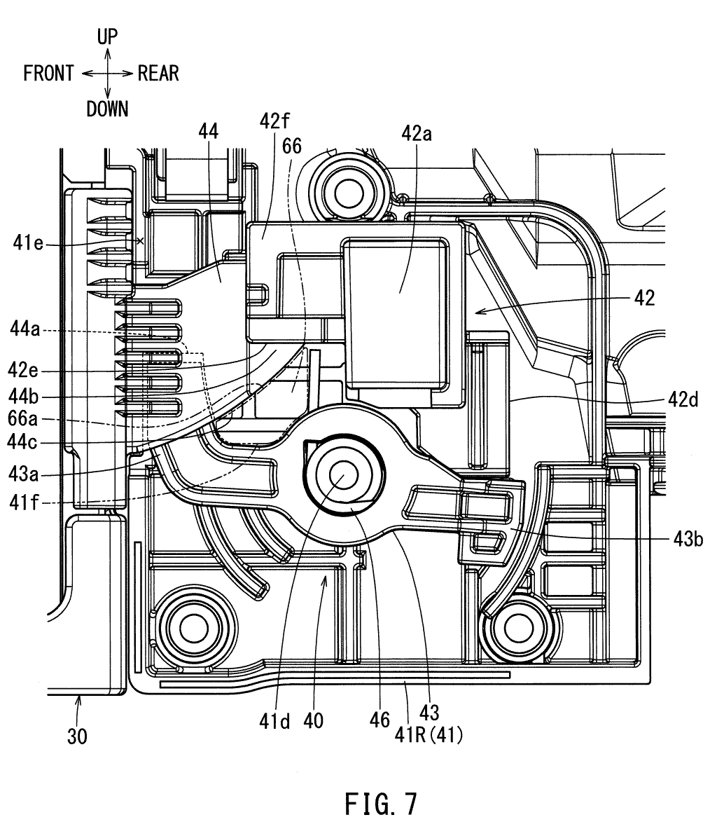

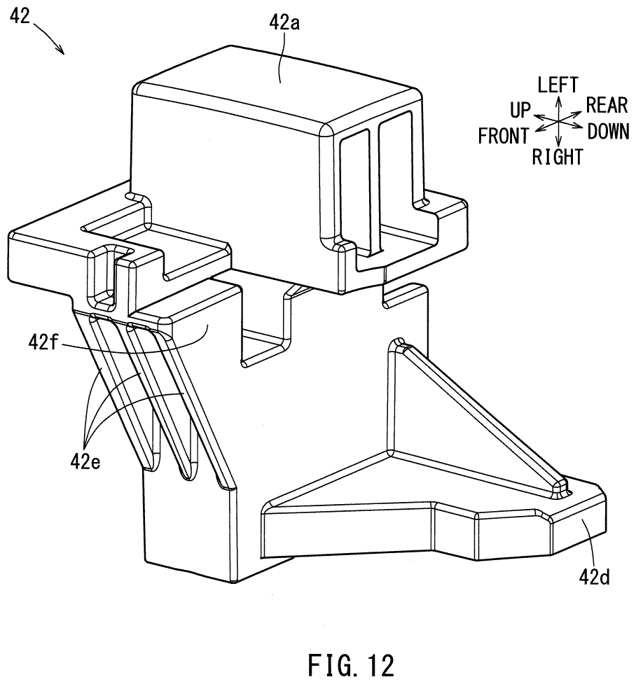

As shown in FIGS. 7 to 9, 12, the operation portion 42 includes an extrusion portion 42f at the front portion thereof. The extrusion portion 42f extends forward. The extrusion portion 42f includes an operating force conversion surface 42e on the right side thereof. The operating force conversion surface 42e is tilted forward as it extends in the leftward direction. As shown in FIG. 12, the operating force conversion surface 42e is formed, for example, by end surfaces of a plurality of ribs arranged in the up-down direction. In other words, the operating force conversion surface 42e includes end surfaces of a plurality of ribs. Instead, the operating force conversion surface 42e may be changed to a single flat tilted surface.

As shown in FIG. 11, a support shaft 41d is formed integrally with the right housing 41R of the lock housing 41. The support shaft 41d extends parallel to the support pole 41a that supports the operation member 42. The lock member 43 is supported so as to be rotatable around the support shaft 41d in the up-down direction. The lock member 43 includes a cylindrical-shaped support 43c approximately at a center of the lock member 43 in its longitudinal direction. The support shaft 41d enters an inner circumferential surface of the support 43c such that the lock member 43 is rotatably supported by the support shaft 41d.

As shown in FIGS. 7 to 11, the lock member 43 includes a lock portion 43a at a front portion thereof. The lock portion 43a extends forward from the support 43c. An end of the lock portion 43a is formed in an L shape bending approximately upward. Furthermore, the lock member 43 includes an engaging portion 43b at a rear portion thereof. The engaging portion 43b extends rearward from the support 43c.

A biasing member 46 is housed in the inner circumference of the support 43c. A torsion spring is used as the biasing member 46. One end of the biasing member 46 engages the lock portion 43. The other end of the biasing member 46 engages the right housing 41R of the lock housing 41. Accordingly, the lock member 43 is biased by the biasing member 46 in a direction to displace the lock portion 43a upward, i.e., a clockwise direction in FIG. 7 (toward the lock position).

The engaging portion 43b of the lock member 43 is biased in a direction to displace downward by the biasing member 46. The operation member 42 is positioned above the engaging portion 43b. When the operation member 42 is positioned on the lock side, the stopper 42d of the operation member 42 is positioned on an upper side of the engaging portion 43b, thereby restricting the engaging portion 43b from displacing upward. Because of this configuration, the lock member 43 is restricted from rotating to the unlock position (in a counterclockwise direction in FIG. 7) against the biasing member 46.

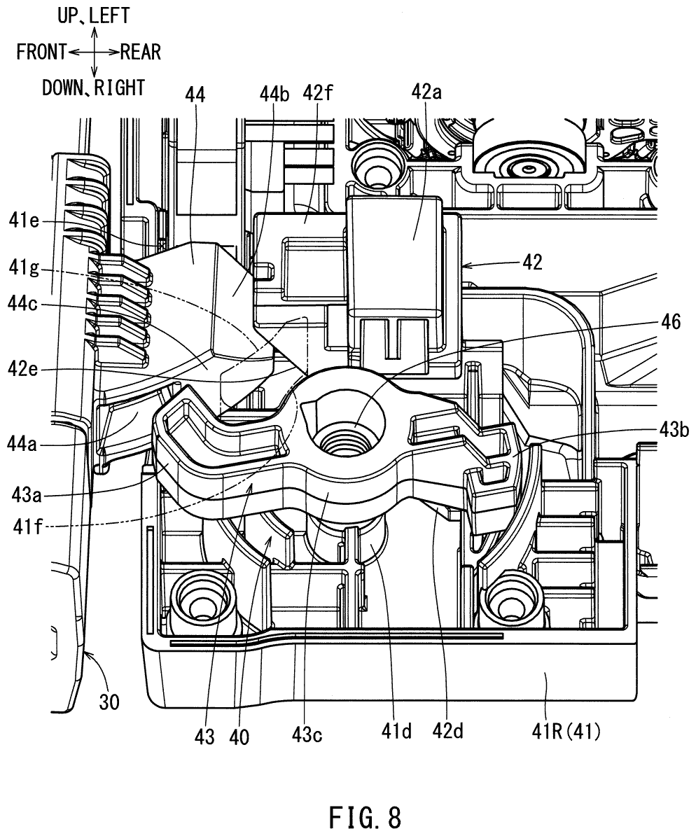

As shown in FIG. 8, when the operation member 42 is pushed rightward, the stopper 42d moves rightward with respect to the engaging portion 43b of the lock member 43. Accordingly, the engaging portion 43b of the lock member 43 is allowed to move upward, and thus the lock member 43 is rotatable to the unlock position.

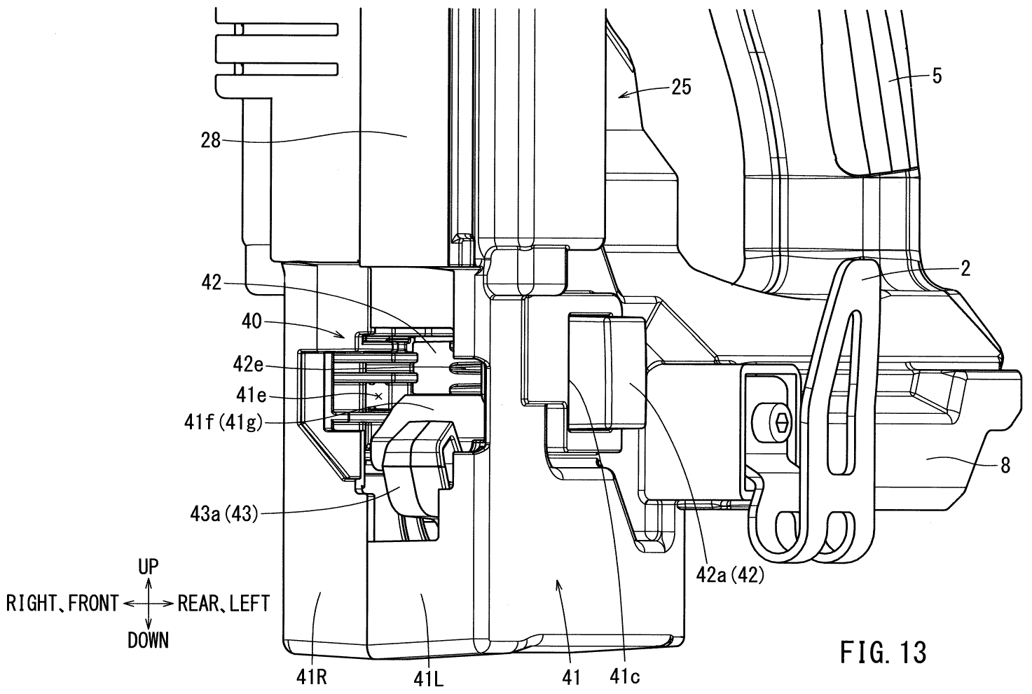

The lock engaging portion 44 is attached to the rear surface of the magazine 30. As shown in FIGS. 6 and 13, a lock window 41e is formed on the front surface of the lock housing 41. When the magazine 30 is attached or detached, the lock engaging portion 44 moves in and out of the lock housing 41 through the lock window 41e.

Referring to FIGS. 8, 9, and 11, the lock engaging portion 44 includes a lock recess 44a, an operating force conversion surface 44b, and a lock guide portion 44c. The lock recess 44a and lock guide portion 44c are formed on the lower surface of the lock engaging portion 44. The lock guide portion 44c is formed in an adjoining area of the rear side of the lock recess 44a. The operating force conversion surface 44b is formed on the left side of the lock engaging portion 44.

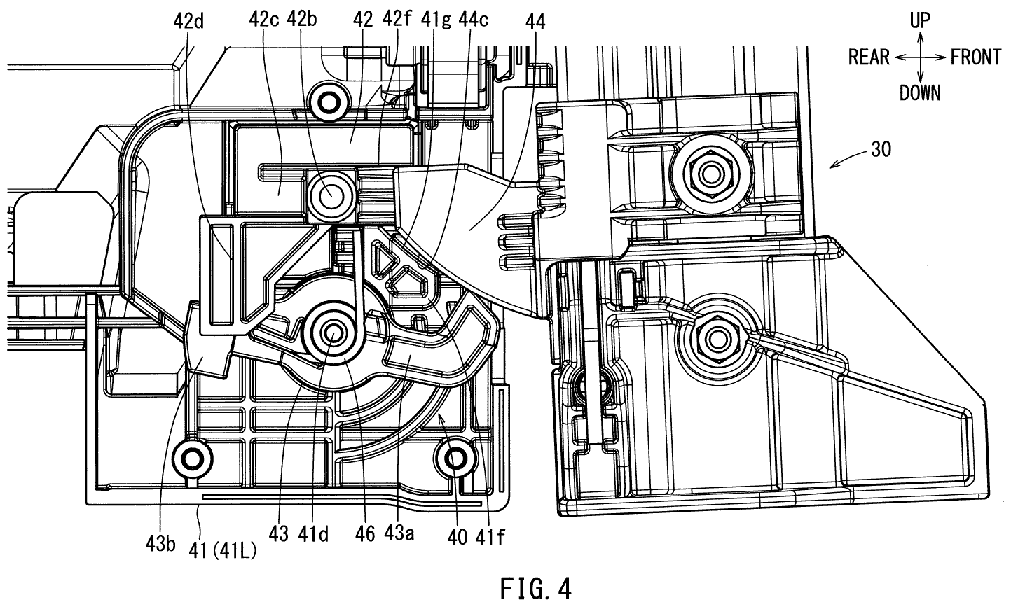

FIGS. 4 and 8 show that the lock engaging portion 44 enters the lock housing 41 through the lock window 41e when the magazine 30 is attached to the tool amin body 10. Alternatively, it may be said that FIGS. 4 and 8 show that the lock engaging portion 44 is being pulled out of the lock housing 41 through the lock window 41e to remove the magazine 30.

Before the magazine 30 is attached to the tool main body 10, the operation member 42 is positioned leftward on the lock side by the biasing force of the compression spring 45. When the lock engaging portion 44 enters the lock housing 41, the operation force conversion surface 44b of the lock engaging portion 44 moves toward a right side of the operating force conversion surface 42e of the operation member 42. The operating force conversion surface 44b of the lock engaging portion 44 is tilted rightward as it extends rearward. Because of this configuration, when the magazine 30 is being attached to the tool main body 10, the operation force conversion surface 44b slidably contacts the operation force conversion surface 42e of the operation member 42, or faces the operation force conversion surface 42e parallel to each other with a slight gap between the two surfaces 44b and 42e.

Before the magazine 30 is attached to the main body housing 10, the lock member 43 is positioned in an initial position beyond the lock position by the biasing member 46. In the initial position of the lock member 43, the engaging portion 43b is far from the stopper 42d of the operation member 42 in the downward direction. Accordingly, the lock member 43 is allowed to rotate toward the unlock position.

When the lock engaging portion 44 enters the lock housing 41 through the lock window 41e, the lock guide portion 44c contacts the lock portion 43a of the lock member 43 located in the initial position. The lock guide portion 44c is typically shaped as a circular arc surface so as to be tilted upward as it extends rearward, allowing it to guide the lock member 43 during attachment and removal. Because of this configuration, when the lock engaging portion 44 enters the lock housing 41, the lock portion 43a of the lock member 43 is pushed downward by lock guide portion 44c. Accordingly, the lock member 43 is rotated toward the unlock position against the biasing force of the biasing member 46.

When the lock engaging portion 44 enters the lock housing 41, the lock member 43 rotates toward the unlock position, thereby relatively moving the lock portion 43a to a front end portion of the lock guide portion 44c. When the lock engaging portion 44 further enters the lock housing 41, the lock portion 43a disengages from the front end portion of the lock guide portion 44c. Accordingly, the lock member 43 is rotated toward the lock position by the biasing force of the biasing member 46, which causes the lock portion 43a to enter the lock recess 44a.

The rotational movement of the lock member 43 to the lock position causes the lock portion 43a to be pulled over a rear surface of the lock recess 44a, thereby pulling the lock engaging portion 44 into the lock housing 41 by the biasing force of the biasing member 46. Because of this movement, the magazine 30 is held in the attachment position as shown in FIGS. 7 and 11. In this attachment position, an upward movement of the engaging portion 43b of the lock member 43 is restricted by the stopper 42d of the operation member 42. Accordingly, the lock portion 43a is held in the lock recess 44a, and thus the magazine 30 is locked in the attachment position.

As shown in FIGS. 4, 7, 8, and 13, a triangular pillar-shaped attachment guide portion 41f is arranged between the operation member 42 and the lock member 43. The attachment guide portion 41f is formed integrally with the inner surface of the left housing 41L. The attachment guide portion 41f is positioned approximately across the right and left housings 41L and 41R of the lock housing 41. The attachment guide portion 41f incudes a guide surface 41g at an upper portion thereof. The guide surface 41g is tilted upward toward the nose 20 as it extends rearward.

While attaching the magazine 30, the lock guide portion 44c of the lock engaging portion 44 contacts the guide surface 41g of the attachment guide portion 41f. As described above, the lock engaging portion 44 is pulled into the lock housing 41 by the biasing force of the biasing member 46, and thus the lock guide portion 44c elastically contacts the guide surface 41g. Because of this configuration, the magazine 30 is guided toward the nose 20 (the nose frame 21).

The magazine 30 is attached to the nose 20 by the biasing force of the biasing member 46, which reduces the gap between the magazine base 23 and the magazine 30 such that the magazine 30 is prevented from rattling.

When removing the magazine 30, the operation member 42 is pushed. Referring to FIGS. 9 and 10, when the operation member 42a of the operation member 42 is pushed rightward, the stopper 42d moves from above the engaging portion 43b of the lock member 43. Because of this movement, the lock member 43 is allowed to rotate to the unlock position. When the operation member 42 is pushed, the operating force conversion surface 42e is pressed against the operating force conversion surface 44b of the lock engaging portion 44. Accordingly, the pushing operation force of the operation member 42 is converted into a force in a direction of pulling the lock engaging portion 44 out of the lock housing 41 (in a removal direction of the magazine 30).

When the lock engaging portion 44 is pushed in the removal direction, the lock portion 43a is pushed against the rear surface of the lock recess 44a, thereby rotating the lock member 43 toward the unlock position. When the operation member 42 is pushed toward the unlock side as shown in FIG. 8, the lock engaging portion 44 moves in the removal direction and the lock member 43 further rotates toward the unlock position. Because of this movement, the lock portion 43a is detached from the lock recess 44a to reach a front end of the lock guide portion 44c.

The magazine lock portion 40 is in an unlocked state when the lock portion 43a is detached from the lock recess 44a. When the lock portion 43a is detached from the lock recess 44a, the lock portion 43a is pressed against the lock guide portion 44c by the biasing force of the biasing member 46. The biasing force of the biasing member 46 acts as a force to displace the magazine 30 in the removal direction via the lock engaging portion 44. Accordingly, the magazine 30 is pushed in the removal direction. In this manner, the magazine 30 is detached from lock engaging portion 44 through a first stage in which the magazine 20 moves in the removal direction by the pushing operation of the operation member 42 and a second stage in which the magazine 30 is pushed in the removal direction by the biasing force of the biasing member 46 of the lock member 43.

According to the first embodiment as described above, when the operation member 42 moves the lock member 43 from the lock position to the unlock position, magazine removal is enabled and the locked state of the magazine 30 by the lock member 43 is released and the magazine 30 is pushed in the removal direction by the extrusion portion 42f of the operation member 42. Because of this movement, operability of the magazine 30 can be improved when removing the magazine 30.

According to the first embodiment, the lock member 43 and the operation member 42 are formed to be separate and movable within the lock housing 41 of the tool main body 10. Because of this configuration, the operation direction of the operation member 42 and the movement direction of lock member 43 toward the unlocked position are different to each other, thereby locking the magazine 30 at the attachment position more reliably in a compact configuration.

According to the first embodiment, the operation member 42 includes the stopper 42d for restricting the lock member 43 from moving to the unlock position. The stopper 42d allows the lock member 43 to move to the unlock position by operating the operation member 42. Because of this configuration, the magazine 30 can be locked at the attachment position by the stopper 42 more reliably.

According to the first embodiment, both of the extrusion portion 42f of the operation member 42 and the lock engaging portion 44 of the magazine 30 which contacts the extrusion portion 42f include operating force conversion surfaces 42e and 44b that convert the operating direction of the operation member 42 to the removal direction of the magazine 30. Accordingly, the magazine 30 is pushed in the removal direction by the operation force of the operation member 42.

According to the first embodiment, the operation direction of the operation member 42 intersects the direction in which the magazine 30 extends (the up-down direction) and the driving direction of the tool main body 10 (the font-rear direction). Because of this configuration, the magazine 30 can be removed by operating the operation member 42 in the lateral direction from the left while the driving tool 1 is grasped.

According to the first embodiment, the lock member 43 is supported by the lock housing 41 of the tool main body 10 around the support shaft 41d extending in the operation direction of the operation member 42. The lock housing 41 is a structural component within the tool main body 10 that houses the lock member 43 and the operation member 42. Because of this configuration, the operation member 42 and lock member 43 can be arranged in a compact manner.

According to the first embodiment, the driving tool 1 includes the biasing member 46 for biasing the lock member 43 toward the lock position, and the biasing force of the biasing member 46 also acts in the removal direction of the magazine 30. Because of this configuration, the magazine 30 is pushed in the removal direction by the biasing force of the biasing member 46.

According to the first embodiment, the magazine 30 includes the lock guide portion 44c and the lock recess 44a. The lock guide portion 44c slides against the lock member 43 and the lock member 43 engages the lock recess 44a when the magazine 30 is attached to the lock housing 41. When the magazine 30 is removed from the lock housing 41, the lock guide portion 44c is pushed in the removal direction by the lock member 43 that is biased by the biasing force of the biasing member 46. Because of this configuration, the lock guide portion 44c functions effectively in both cases where the magazine 30 is attached to and detached from the lock housing 41.

According to the first embodiment, the magazine 30 is pushed in the removal direction by the operation of the operation member 42, and the magazine 30 is further pushed in the removal direction by the biasing force of the biasing member 46 when the lock member 43 moves to the unlock position. Because of this configuration, the magazine 30 is removed from the tool main body 10 through a first stage in which the magazine 30 is pushed in the removal direction by the operation member 42 and a second stage in which the magazine 30 is pushed in the removal direction by the biasing force of the biasing member 46.

According to the first embodiment, the tool main body 10 includes the nose 20 which attaches to the magazine 30 and extends in the driving tool direction. The tool main body 10 also includes the attachment guide portion 41f that guides the magazine 30 toward the nose 20 when the magazine 30 is attached to the nose 20. Because of this configuration, the magazine 30 can be attached to the nose 20 without rattling.

According to the first embodiment, the magazine 30 is locked in the attachment position by the lock member 43 when the magazine 30 moves to a side of the tool main body 10. Because of this configuration, the magazine 30 can be attached to the tool main body 10 with a one-touch operation.

Various modifications can be made to the driving tool 1 in the first embodiment. In the above embodiment, the operation member 42 is biased toward the lock side by the compression spring 45. However, a leaf spring may be used instead of the compression spring 45.

In the above embodiment, the operation member 42a of the operation member 42 is arranged on the left side of the lock housing 41. Instead, the operation member 42a may be arranged on the right side of the lock housing 41.

Both or one of the operating force conversion surface 42e of the lock member 42 and the operating force conversion surface 44b of the lock engaging portion 44 may be formed in a curved surface shape.

In the above embodiment, the lock guide portion 44c is formed to have a circular arc surface. Instead, the lock guide portion 44c may be formed in a tilted surface or in a curved surface.

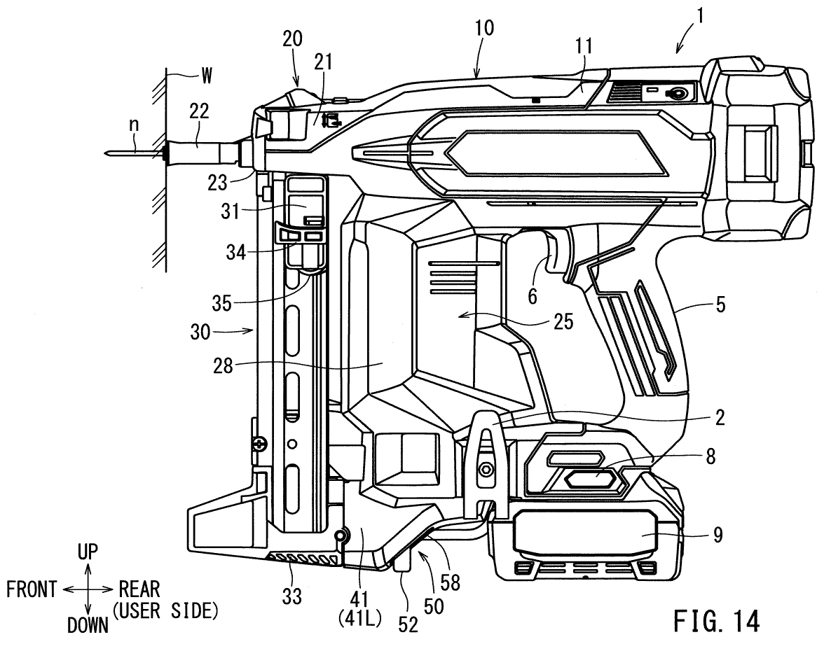

FIGS. 14 to 16 show a magazine lock portion 50 according to a second embodiment. Descriptions of the members and configurations that do not need to be modified and are in common with the first embodiment are omitted by use of the same reference numerals. The magazine lock portion 50 of the second embodiment includes a lock member 51 that is supported by a lock housing 41 of the tool main body 10. The lock member 51 is made of a single member and integrally includes an operation lever 52, a lock arm 53, a stopper 54, and an extrusion portion 55. The second embodiment differs from the first embodiment in that the operation member 42 and lock member 43 in the first embodiment are separate members that can be moved in different directions from each other.

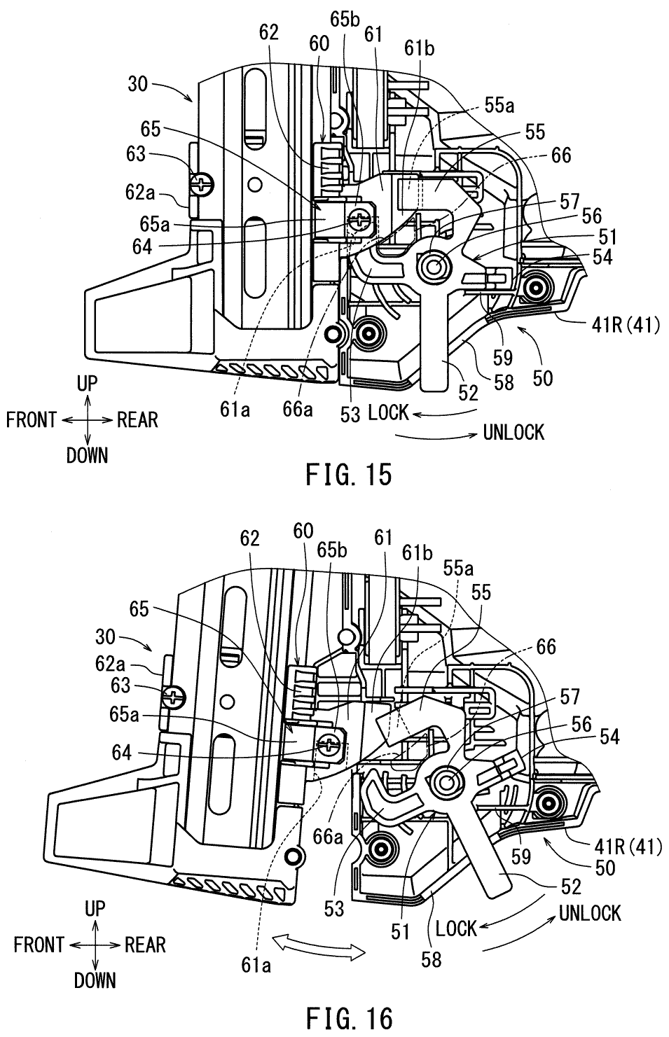

The lock member 51 is rotatably supported by the right housing 41R around a support shaft 56. The lock member 51 is rotatable around the support shaft 56, an axis of which intersects (orthogonal to) both the feeding direction of the driving tool n in the magazine 30 and the driving direction of the driving tool n in the tool main body 10. The lock member 51 is biased in a clockwise direction in FIGS. 15 and 16 by a biasing force of a biasing member 57 that is held around the support shaft 56. The operation lever 52, the lock arm 53, the stopper 54, and the extrusion portion 55 are arranged at approximately four equally spaced positions around the support shaft 56.

The operation lever 52 extends downward with respect to the support shaft 56. As shown in FIG. 14, a rectangular window 58 is formed on the lower surface of the lock housing 41. The window 58 is formed on the left housing 41L. An end portion of the operation lever 52 extends downward from the lock housing 41 through the window 58. As shown in FIG. 15, when the lock member 51 is on a lock side, the operation lever 52 is at a lock position where the operation lever 52 extends downward from the window 58. On the contrary, when the lock member 51 is on an unlock side as shown in FIG. 16, the operation lever 52 is at an unlock position where the operation lever 52 extends from the window 58 obliquely downward in a rearward direction. The operation lever 52 is rotatably operable from outside of the housing 41 within a range of about 45° between the lock position and the unlock position.

The lock arm 53 extends forward with respect to the support shaft 56. Similar to the lock member 43 in the first embodiment, an end of the lock arm 53 is formed in an L shape bending approximately upward. Similar to the first embodiment, the tip end side of the lock arm 53 engages the lock engaging portion 61 of the magazine holder 60 to lock the magazine 30. The lock engaging portion 61 includes a lock recess 61a at the lower surface thereof in the same manner as in the first embodiment. As shown in FIG. 15, the end portion of the lock arm 53 enters the lock recess 61a to engage the lock engaging portion 61.

The stopper 54 extends rearward with respect to the support shaft 56. A stopper receiving portion 59 is formed on an inner surface of the right housing 41R. As shown in FIG. 15, when the lock member 51 is on the lock side, the stopper 54 contacts the stopper receiving portion 59 from above by a biasing force of the biasing member 57. Accordingly, the lock member 51 is prevented from rotating in the clockwise direction (further rotating on the lock side).

The extrusion portion 55 extends upward with respect to the support shaft 56. The extrusion portion 55 corresponds to the extrusion portion 42f of the first embodiment. Similar to the first embodiment, an operating force conversion surface 55a is formed on the right side of the extrusion portion 55. When the magazine 30 engages the lock member 51, the operating force conversion surface 55a contacts the lock engaging portion 61 of the magazine holder 60. Similar to the first embodiment, an operating force conversion surface 61b is formed on left side of the lock engaging portion 61. When the magazine 30 engages the lock member 51, the operating force conversion surface 61b contacts the operating force conversion surface 55a of the extrusion portion 55.

Similar to the first embodiment, the lock engaging portion 61 is arranged at a lower portion of the magazine 30, extending rearward. The lock engaging portion 61 is integrally formed in a magazine holder 60. Also, a holder 62 is integrally formed in the magazine holder 60. The lock engaging portion 61 is formed at a rear portion of the holder 62. The holder 62 extends forward from the lock engaging portion 61 to a front portion 62a through a right side of magazine 30. The front portion 62a of the holder 62 is attached to the front end portion of the magazine 30 with a fixing screw 63.

A rear portion of the holder 62 is held firmly to the magazine 30 by use of a metal clip 65. The clip 65 has a U-shaped pinching portion 65a. The pinching portion 65a elastically holds the rear portion of the holder 62 and the rear portion of the magazine 30. Because of this configuration, the holder 62, especially a rear portion of the holder 62, firmly holds the magazine 30.

An extending portion 65b is integrally formed at a rear portion of the pinching portion 65a of the clip 65. The extending portion 65b is screw-fixed to a left side portion of the lock engaging portion 61 with a fixing screw 64. Accordingly, the clip 65 is firmly attached to the lock engaging portion 61. The clip 65 increases a supporting rigidity of the lock engaging portion 61 with regard to the magazine 30.

Similar to the first embodiment, a triangular pillar-shaped attachment guide portion 66 is formed between the lock member 51 and the lock engaging portion 61. The attachment guide portion 66 is integrally formed in an inner surface of the left housing 41L. A guide surface 66a is formed at an upper portion of the attachment guide portion 66. When the magazine 30 is attached to the lock housing 41, the lock engaging portion 61 contacts the guide surface 66a and is guided upward, thereby pushing the magazine 30 toward the nose 20. Because of this configuration, the magazine 30 is attached to the magazine base 23 without rattling, and thus a driving member n is smoothly supplied to the driving passage 20a.

As shown in FIG. 15, in the locked state of the magazine lock portion 50, the end portion of the lock arm 53 enters the lock recess 61a of the lock engaging portion 61. The operating force conversion surface 55a of the extrusion portion 55 contacts the operating force conversion surface 61b of the lock engaging portion 61. The stopper 54 contacts the stopper receiving portion 59.

The magazine lock 30 is attached to the tool main body 10 without rattling by engaging the lock arm 53 and the extrusion portion 55 of the lock member 51 with the lock engaging portion 61 having high supporting rigidity by use of the clip 65.

When removing the magazine 30 from the tool main body 10, the operation lever 52 is rotated to the unlock position (rearward) as shown in FIG. 16. The operation lever 52 is rotated to the unlock position against the biasing force of the biasing member 57. When the lock member 51 rotates counterclockwise as shown in FIG. 16, the lock arm 53 is pulled out from the lock recess 61a. Also, the lock engaging portion 61 is pushed forward by the extrusion portion 55. The lock engaging portion 61 is pushed by the rotation operation force of the operation lever 52.

By the rotation operation of the operation lever 52, the lock arm 53 is disengaged from the lock recess 61a, and also the lock engaging portion 61 is pushed by the extrusion portion 55. Because of this movement, the magazine 30 is pushed forward to be removed from the tool amin body 10. In a state where the magazine 30 is removed from the tool main body 10, when the rotation operation of the operation lever 52 on the unlock side is released, the operation lever 52 rotates in the clockwise direction in FIG. 16 by the biasing force of the biasing member 57 to return to an initial position beyond the lock position.

To attach the magazine 30 to the tool main body 10, it is sufficient to rotate the magazine 30 rearward while the upper position of the magazine 30 engages the magazine base 23. By the rearward rotation of the magazine 30, the lock engaging portion 61 enters the lock housing 41. The tip portion of the lock arm 53 contacts the lower surface of the lock engaging portion 61 in the lock housing 41. When the lock engaging portion 61 further enters the lock housing 41 with the lock engaging portion contacting the tip portion of the lock arm 53, the lock member 51 rotates counterclockwise against the biasing force of the biasing member 57 from the initial position. After the tip portion of the lock arm 53 contacts the lower surface of the lock engaging portion 61 and is guided downward, the lock arm 53 enters the lock recess 61a. When the lock arm 53 enters the lock recess 61a, the lock engaging portion 61 is further pulled into the lock housing 41 by the biasing force of the biasing member.

By the pulling operation of the lock member 51, the lock engaging portion 61 is pushed rightward by the operating force conversion surface 55a of the extrusion portion 55. Also, the lock engaging portion 61 contacts the guide surface 66a of the attachment guide portion 66. Because of this movement, the lock engaging portion 61 is guided upward. The operation lever 52, together with the lock arm 53 and the extrusion portion 55, returns to the lock position by the biasing force of the biasing member 57. When the operation lever 52 returns to the lock position and the lock arm 53 enters the lock recess 61a of the lock engaging portion 61, the magazine 30 is locked in the attachment position

According to the magazine lock portion 50 in the second embodiment described above, when the operation lever 52 rotates to the unlock position, the magazine 30 is released from the locked state by the lock arm 53 and is pushed in the removal direction by the extrusion portion 55. Because of this configuration, a removing operability of the magazine 30 can be improved.

In the second embodiment, the lock member 50 is integrally formed with the operation lever 52, the lock arm 53, the extrusion portion 55 and the stopper 54, simplifying the configuration of the magazine lock portion 50.

In the first and second embodiments, a gas spring type driving tool is illustrated as the driving tool 1. However, the magazine lock portions 40 and 50 can be applied to, for example, a compressed air type driving tool driven by externally supplied compressed air, a mechanical spring type driving tool using a thrust force of a compressed spring as the driving force, or an electric wheel type driving tool.

We claim:

1. A driving tool comprising:
a tool main body configured to drive a driving member;
a magazine removably attached to the tool main body and house a plurality of driving members;
a lock member configured to secure the magazine within the tool main body so as not to be disengaged from the tool main body;
an operation member configured to move the lock member from a lock position to an unlock position for enabling magazine removal; and
an extrusion portion formed in the operation member, the extrusion portion being configured to push the magazine in a removal direction with respect to the tool main body through the operation of the operation member to move the lock member to the unlock position.

2. The driving tool according to claim 1, wherein the lock member and the operation member are separate and movable within the tool main body.

3. The driving tool according to claim 2, further comprising a stopper formed in the operation member,
wherein the stopper is configured to prevent the lock member from moving to the unlock position and to allow the lock member to move to the unlock position when the operation member is actively operated.

4. The driving tool according to claim 1, wherein an operation direction of the operation member intersects both a loading direction of the driving member in the magazine and a driving direction of the driving member in the tool main body.

5. The driving tool according to claim 1, wherein the lock member is rotatably supported by the tool main body around a support shaft extending in parallel with an operation direction of the operation member.

6. The driving tool according to claim 1, wherein the lock member and the operation member are integrally formed and movable with respect to the tool main body.

7. The driving tool according to claim 1, wherein the lock member moves between the lock position and the unlock position by rotation of the lock member.

8. The driving tool according to claim 1, further comprising a lock engaging portion formed in the magazine and configured to contact the extrusion portion of the operation member,
wherein at least one of the extrusion portion and the lock engaging portion includes an operation force conversion surface via which an operation direction of the operation member is converted to the removal direction of the magazine.

9. The driving tool according to claim 1, further comprising a biasing member configured to bias the lock member toward the lock position,
wherein the magazine and the biasing member is configured such that a biasing force of the biasing member is also applied in the removal direction of the magazine.

10. The driving tool according to claim 9, further comprising a lock guide portion and a lock recess both formed in the magazine, wherein,
the lock guide portion slidably contacts the lock member when the magazine is attached to the tool main body,
the lock recess is configured to engage the lock member, and
the lock guide portion is pushed in the removal direction of the magazine by the lock member owing to the biasing force of the biasing member when the magazine is removed from the tool main body.

11. The driving tool according to claim 10, wherein the driving tool has a structure in which the magazine is pushed in the removal direction by the operation of the operation member, and wherein the magazine is further pushed in the removal direction by the biasing force of biasing member when the lock member moves to the unlock position.

12. The driving tool according to claim 1, further comprising a nose located at a front portion of the tool main body extending in a driving direction of the driving member, wherein the nose is attachable to the magazine,
wherein the magazine is pushed toward a side of the nose when the magazine is attached to the tool main body.

13. The driving tool according to claim 1, wherein the magazine is configured to be secured in an attachment position by the lock member when the magazine moves to a side of the tool main body.

14. The driving tool according to claim 1, further comprising a lock housing formed within the tool main body, the lock housing having a half-split housing structure including a left housing and a right housing, wherein,
the lock member and the operation member are arranged within the lock housing, and
an operation portion of the operation member protrudes outside of the lock housing through a window formed either in the left housing or the right housing.

15. The driving tool according to claim 14, further comprising a biasing member which biases the operation member toward the window.

16. The driving tool according to claim 8, wherein the operation force conversion surface includes end surfaces of a plurality of ribs formed in the operation member.

17. The driving tool according to claim 8, wherein the operation force conversion surface is a tilted surface or a curved surface.

18. The driving tool according to claim 12, further comprising an attachment guide portion including a guide surface that is configured to guide the magazine to the side of the nose when the magazine is attached to the tool main body.

19. The driving tool according to claim 18, wherein the attachment guide portion is formed integrally with an inner surface of the tool main body between the lock member and the operation member.

20. The driving tool according to claim 10, wherein the lock guide portion for guiding the lock member during attachment and removal of the magazine is shaped as a circular arc surface or a tilted surface.
